(19) United States
(12) Patent Application Publication
(10) Pub. No.: US 2014/0267983 A1
(43) Pub. Date: Sep. 18, 2014

(54) SWITCHABLE GLASS PATCH, SWITCHABLE GLASS, AND MANUFACTURING METHOD THEREOF

(71) Applicant: Yi-Ta Chen, (US)

(72) Inventors: Kuo-Chen HSU, Miaoli County (TW); Yi-Ta Chen, Miaoli County (TW)

(73) Assignee: Yi-Ta Chen, Miaoli County (TW)

(21) Appl. No.: 13/841,088

(22) Filed: Mar. 15, 2013

(51) Int. Cl. G02F 1/1333; B32B 37/18; G02F 1/1334; B29C 65/48

(52) U.S. Cl. CPC G02F 1/133345; B29C 65/48; B32B 37/18; G02F 1/1334
USPC 349/86; 156/99

(57) ABSTRACT

A switchable glass patch is provided, which includes a first glass layer, a first transparent conductive film, a second glass layer, a second transparent conductive film, and a liquid crystal layer. The first glass layer and the second glass layer have the thickness less than 0.3 mm and are flexible. The first transparent conductive film is formed on a first side the first glass layer, and the second transparent conductive film is formed on a first side of the second glass layer. The liquid crystal layer is arranged between the first transparent conductive film and the second transparent conductive film, so that the first transparent conductive film and the second transparent conductive film face each other.

### BACKGROUND

1. Technical Field

The disclosure relates to a glass, and in particular, to a switchable glass patch, a switchable glass, and a manufacturing method thereof.

2. Related Art

PDLC film is an abbreviation of Polymer-dispersed Liquid Crystal Film, which is a composite film with liquid crystal droplets having anisotropy uniformly dispersed in polymer. The refractive index between the liquid crystal and the polymer can be adjusted through an externally applied electric field, thereby causing light scattering and light transmission state, and achieving the function of controlling luminance by the film. Typical liquid crystal has positive dielectric anisotropy, and the molecular type thereof mainly includes Nematic, Smetic, ChCLC, Ferroelectric, Antiferroelectric Smetic, Guest-Host, and other states. When no voltage is applied externally, the effective refractive index Neff of the liquid crystal and the refractive index Np of the polymer do not match with each other, the incident light feels the existence of many interfaces, the light is seriously scattered, so the film forms a scattering state (Off State). Once an electric field is produced, the liquid crystal is arranged to be vertical to the surface of the substrate. Because the refractive index No of the liquid crystal is the same as the refractive index Np of the polymer, the vertically incident light is transmittable by the light since there is no interface therein, and therefore, the film is as an On State. Such a display mode is referred to as a Normal Mode PDLC, and otherwise, it is referred to as a Reverse Mode PDLC.

The PDLC is applied in many aspects, including a switchable glass, which adjusts the luminance flux by using the transparent and non-transparent characteristics of the PDLC under different electric fields, thereby achieving a preferable efficacy of energy saving and carbon reduction.

The structure of a conventional switchable glass is as shown in FIG. 1A and FIG. 1B, which are respectively corresponding to states of not being powered on (FIG. 1A) and being powered on (FIG. 1B). The structure of the switchable glass, from the glass end, includes: glass 10, an adhesive layer 62, a second polyethylene terephthalate fiber (PET) layer 22, a second transparent conductive film 24, a liquid crystal layer 26 (containing PDLC), a first transparent conductive film 23, a first PET layer 21, an adhesive layer 61, and a thin glass layer 30.

In FIG. 1A, the switchable glass is in the state of not being powered on, and at this time, the PDLC 25 therein is in a random direction. Therefore, the incident light can be easily reflected out, so the light transmission rate is largely reduced. In FIG. 1B, the switchable glass is in the state of being powered on, and at this time, the PDLC 25 therein is in a fixed direction controlled by the voltage. Therefore, the incident light is easily transmitted through. By means of voltage of different intensities, a rotating angle of the PDLC can be controlled, so as to adjust the light transmission rate.

The switchable glass manufactured by the PDLC patch made of PET is advantageous in being easily manufactured, but is disadvantageous in short lifetime thereof. The reason lies in that, the material of PET has hydrophilicity, control over water molecular vapor pressure must be conducted during the production of the ITO film. After the glass is pasted to the PET switchable patch, another thin glass layer 30 needs to be further pasted thereon, thereby causing an increase in the cost, which is shown in the structures of FIG. 1A and FIG. 1B. Moreover, the PET material, under direct sunlight for a long time, may easily generate quality deterioration, and further form a change in color, so that a surface speckling of the switchable glass is caused. Therefore, the sales and promotion of the switchable glass are affected.

Therefore, how to design a switchable glass patch with a better optical characteristic and no surface speckling problem has become a key issue in the development of PDLC-type switchable glass technology.

### SUMMARY

In view of the above problem in the prior art, the disclosure provides a switchable glass patch, which includes a first glass layer, a first transparent conductive film, a second glass layer, a second transparent conductive film, and a liquid crystal layer. The first glass layer and the second glass layer have the thickness less than 0.3 mm and are flexible. The first transparent conductive film is formed on a first side the first glass layer, and the second transparent conductive film is formed on a first side of the second glass layer. The liquid crystal layer is arranged between the first transparent conductive film and the second transparent conductive film, so that the first transparent conductive film and the second transparent conductive film face each other.

The disclosure further provides a switchable glass, which includes a first glass layer, a first transparent conductive film, a second glass layer, a second transparent conductive film, a liquid crystal layer, an adhesive layer, and a main glass layer. The first glass layer and the second glass layer have the thickness less than 0.3 mm and are flexible. The first transparent conductive film is formed on a first side of the first glass layer, and the second transparent conductive film is formed on a first side of the second glass layer. The liquid crystal layer is arranged between the first transparent conductive film and the second transparent conductive film, so that the first transparent conductive film and the second transparent conductive film face each other. The adhesive layer is adhered between a second side of the second glass layer and the main glass layer.

The disclosure further provides a switchable glass, which includes a first glass layer, a first transparent conductive film, a second glass layer, a second transparent conductive film, a liquid crystal layer, a first adhesive layer, a soft material layer, a second adhesive layer, and a main glass layer. The first glass layer and the second glass layer have the thickness less than 0.3 mm and are flexible. The first transparent conductive film is formed on a first side of the first glass layer, and the second transparent conductive film is formed on a first side of the second glass layer. The liquid crystal layer is arranged between the first transparent conductive film and the second transparent conductive film, so that the first transparent conductive film and the second transparent conductive film face each other. The first adhesive layer is adhered between a second side of the second glass layer and the soft material layer, and the second adhesive layer is adhered between the other side of the soft material layer and the main glass layer.

The disclosure further provides a manufacturing method of a switchable glass patch roll, which includes: forming a polymer liquid crystal layer on a surface of a conductive layer of a first flexible conductive glass layer; arranging a surface of a conductive layer of a second flexible conductive glass layer on the other side of the polymer liquid crystal layer to constitute flexible polymer liquid crystal glass; adhering a soft material substrate with double adhesive layers on the flexible polymer liquid crystal glass; and rolling the flexible liquid crystal glass to form a roll shape.

Hereinafter, the detailed features and advantages of the disclosure are stated in detail, and the content thereof is sufficient for any person skilled in the art to know the technical content of the disclosure and implement the same thereby. Moreover, according to the content, claims, and figures disclosed in the present specification, any person skilled in the art can easily understand the objective and advantages of the disclosure.

### BRIEF DESCRIPTION OF THE DRAWINGS

The disclosure will become more fully understood from the detailed description given herein below for illustration only, and thus not limitative of the disclosure, wherein:

FIG. 1A to FIG. 1B are schematic views of a structure of a PDLC switchable plastic patch according to the conventional art before being powered on and after being powered on;

FIG. 2A to FIG. 2B are structural views of a PDLC switchable glass patch according to a specific embodiment of the disclosure, which are respectively schematic structural views thereof before being pasted to glass and after being pasted to glass;

FIG. 3A to FIG. 3B are structural views of a PDLC switchable glass patch according to another specific embodiment of the disclosure, which are respectively schematic structural views thereof before being pasted to glass and after being pasted to glass;

FIG. 4 is a schematic view of rolling a PDLC switchable glass patch into a roll shape according to the disclosure; and

FIG. 5 is a flow chart of a manufacturing method of a PDLC switchable glass patch according to the disclosure.

### DETAILED DESCRIPTION

The disclosure applies an ITO roll glass manufactured by flexible glass to manufacture a PDLC switchable glass patch and a switchable glass, which can achieve the technical efficacy of high transmittance, long lifetime, non-speckling, and non-hydrophilicity.

Please refer to FIG. 2A and FIG. 2B, in which structural views of a PDLC switchable glass patch according to a specific embodiment of the disclosure are shown, which are respectively schematic structural views thereof before being pasted to glass and after being pasted to glass.

In FIG. 2A, the switchable glass patch includes a first glass layer 71, a first transparent conductive film 23, a second glass layer 72, a second transparent conductive film 24, a liquid crystal layer 26, an adhesive layer 62, a soft material layer 80, an adhesive layer 63, and a release layer 90. The first glass layer 71 and the second glass layer 72 have the thickness less than 0.3 mm and are flexible. The first transparent conductive film 23 is formed on a first side of the first glass layer 71. The second transparent conductive film 24 is formed on a first side of the second glass layer 72. The liquid crystal layer 26 is arranged between the first transparent conductive film 23 and the second transparent conductive film 24, so that the first transparent conductive film 23 and the second transparent conductive film 24 face each other. The adhesive layer 62 is adhered between a second side of the second glass layer and the soft material layer 80. The adhesive layer 63 is adhered between the soft material layer 80 and the release layer 90. Therefore, the soft material layer 80 is adhered to the adhesive layer 62 and faces the second side of the second glass layer 72, and the soft material layer 80 is adhered to the adhesive layer 63 and faces the release layer 90. The release layer 90 is strippable to enable the adhesive layer 63 to be adhered to another surface, such as glass.

By means of the above structure, the switchable glass patch can be easily manufactured, and adhere to a main glass surface through the adhesive layer 63.

The material of the soft material layer 80 is selected from: polyethylene terephthalate fiber (PET), polycarbonate (PC), polyimide film (PI), polymethyl methacrylate (PMMA), or triallyl cyanurate (TAC).

FIG. 2B is a schematic view of the switchable glass patch after being pasted to the main glass. It can be found that, the release layer 90 is replaced by glass 10.

Please refer to FIG. 3A and FIG. 3B, in which structural views of a PDLC switchable glass patch according to another specific embodiment of the disclosure are shown, which are respectively schematic structural views thereof before being pasted to glass and after being pasted to glass.

In FIG. 3A, the switchable glass patch includes a first glass layer 71, a first transparent conductive film 23, a second glass layer 72, a second transparent conductive film 24, a liquid crystal layer 26, an adhesive layer 63, and a release layer 90. The first glass layer 71 and the second glass layer 72 have the thickness less than 0.3 mm and are flexible. The first transparent conductive film 23 is formed on a first side of the first glass layer 71. The second transparent conductive film 24 is formed on a first side of the second glass layer 72. The liquid crystal layer 26 is arranged between the first transparent conductive film 23 and the second transparent conductive film 24, so that the first transparent conductive film 23 and the second transparent conductive film 24 face each other. The adhesive layer 63 is adhered between the second glass layer 72 and the release layer 90. Therefore, the second glass layer 72 is adhered to the adhesive layer 63 and faces the release layer 90. The release layer 90 is strippable to enable the adhesive layer 63 to be adhered to another surface, such as glass.

By means of the above structure, the switchable glass patch can be easily manufactured, and adhered to a main glass surface through the adhesive layer 63.

FIG. 3B is a schematic view of the switchable glass patch after being pasted to the main glass. It can be found that, the release layer 90 is replaced by glass 10.

Please refer to FIG. 4, in which a schematic view of rolling the PDLC switchable glass patch into a roll shape according to the disclosure is shown, which is the schematic view of the embodiment in FIG. 2A. The switchable glass patch roll includes flexible polymer liquid crystal glass 70, a soft material layer 80, and a release layer 90. In FIG. 4, a part of the adhesive layer is not shown. After the structure is manufactured, because a part of the switchable glass layer is made of flexible glass, the thickness thereof is less than 0.3 mm. Therefore, the switchable glass patch of the disclosure can be rolled into a roll shape, so as to facilitate the manufacturing process and the carriage after the manufacturing.

Please refer to FIG. 5, in which a flow chart of a manufacturing method of the PDLC switchable glass patch according to the disclosure is shown, which includes the following steps.

Step 102: Form a polymer liquid crystal layer on a surface of a conductive layer of a first flexible conductive glass layer.

Step 104: Arrange a surface of a conductive layer of the second flexible conductive glass layer on the other side of the polymer liquid crystal layer to constitute flexible polymer liquid crystal glass.

Step 106: Adhere a soft material substrate with double adhesive layers to the flexible polymer liquid crystal glass.

Step 108: Roll the flexible polymer liquid crystal glass into a roll shape.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A switchable glass patch, comprising:
a first glass layer, having the thickness less than 0.3 mm and being flexible;
a first transparent conductive film, formed on a first side of the first glass layer;
a second glass layer, having the thickness less than 0.3 mm and being flexible;
a second transparent conductive film, formed on a first side of the second glass layer; and
a liquid crystal layer, arranged between the first transparent conductive film and the second transparent conductive film, so that the first transparent conductive film and the second transparent conductive film face each other.

2. The switchable glass patch according to claim 1, further comprising:
an adhesive layer, adhered to a second side of the second glass layer; and
a release layer, adhered to the adhesive layer and facing the second side of the second glass layer, the release layer being strippable to enable the adhesive layer to be adhered to another surface.

3. The switchable glass patch according to claim 1, further comprising:
a first adhesive layer, adhered to a second side of the second glass layer; and
a soft material layer, adhered to the first adhesive layer and facing the second side of the second glass layer.

4. The switchable glass patch according to claim 3, wherein the material of the soft material layer is selected from: polyethylene terephthalate fiber (PET), polycarbonate (PC), polyimide film (PI), polymethyl methacrylate (PMMA), or triallyl cyanurate (TAC).

5. The switchable glass patch according to claim 3, further comprising:
a second adhesive layer, adhered to the other side of the soft material layer; and
a release layer, adhered to the second adhesive layer and facing the other side of the soft material layer, the release layer being strippable to enable the second adhesive layer to be adhered to another surface.

6. A switchable glass, comprising:
a first glass layer, having the thickness less than 0.3 mm and being flexible;
a first transparent conductive film, formed on a first side of the first glass layer;
a second glass layer, having the thickness less than 0.3 mm and being flexible;
a second transparent conductive film, formed on a first side of the second glass layer;
a liquid crystal layer, arranged between the first transparent conductive film and the second transparent conductive film, so that the first transparent conductive film and the second transparent conductive film face each other;
a main glass layer; and
an adhesive layer, adhered between a second side of the second glass layer and the main glass layer.

7. A switchable glass, comprising:
a first glass layer, having the thickness less than 0.3 mm and being flexible;
a first transparent conductive film, formed on a first side of the first glass layer;
a second glass layer, having the thickness less than 0.3 mm and being flexible;
a second transparent conductive film, formed on a first side of the second glass layer;
a liquid crystal layer, arranged between the first transparent conductive film and the second transparent conductive film, so that the first transparent conductive film and the second transparent conductive film face each other;
a soft material layer;
a main glass layer;
a first adhesive layer, adhered between a second side of the second glass layer and the soft material layer; and
a second adhesive layer, adhered between the other side of the soft material layer and the main glass layer.

8. The switchable glass patch according to claim 7, wherein the material of the soft material layer is selected from: polyethylene terephthalate fiber (PET), polycarbonate (PC), polyimide film (PI), polymethyl methacrylate (PMMA), or triallyl cyanurate (TAC).

9. A manufacturing method of a switchable glass patch roll, comprising:
forming a polymer liquid crystal layer on a surface of a conductive layer of a first flexible conductive glass layer;
arranging a surface of a conductive layer of a second flexible conductive glass layer on the other side of the polymer liquid crystal layer to constitute a flexible polymer liquid crystal glass;
adhering a plastic substrate with double adhesive layers on the flexible polymer liquid crystal glass; and
rolling the flexible polymer liquid crystal glass to form a roll shape.
